(19) United States
(12) Patent Application Publication
(10) Pub. No.: US 2007/0118692 A1
(43) Pub. Date: May 24, 2007

(54) COMPUTER SYSTEM AND METHOD FOR SELECTIVELY SUPPORTING AT LEAST ONE REGISTERED DUAL INLINE MEMORY MODULE OR AT LEAST ONE UNBUFFERED DUAL INLINE MEMORY MODULE

(76) Inventor: Ming-Che Yu, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/278,565

(22) Filed: Apr. 4, 2006

(30) Foreign Application Priority Data
Nov. 23, 2005 (TW) 094141168

(51) Int. Cl. G06F 12/00

(52) U.S. Cl. 711/115

(57) ABSTRACT

A computer system and method for selectively supporting at least one registered dual inline memory module or at least one unbuffered dual inline memory module is disclosed. The computer system includes a printed circuit board, at least one registered/unbuffered dual mode dual inline memory module socket, a central processing unit for communicating three sets of clock signals to each of the registered/unbuffered dual mode dual inline memory module sockets, and a basic input/output system for detecting a memory type of a memory module inserted in each of the registered/unbuffered dual mode dual inline memory module sockets.

### BACKGROUND OF THE INVENTION

1. Field of the Invention

The present invention relates to a computer system and method, and, more particularly, to a computer system and method for selectively supporting at least one registered dual inline memory module or at least one unbuffered dual inline memory module.

2. Description of the Related Art

Unbuffered dual inline memory modules (unbuffered DIMMs) and registered dual inline memory modules (registered DIMMs) are two common memory module types.

Unbuffered DIMMs are dual inline memory modules that are not buffered, and are typically used for desktop computers. Unbuffered DIMMs have various benefits, such as being inexpensive, popular, and providing fast speeds and high performance characteristics.

Registered DIMMs are dual inline memory modules whose address and control signals are registered, clocks are locked by phase locked loops (PLL), and are used for workstations and servers. Registered DIMMs provide better stability, but have the draw backs of slower speeds and higher prices; registered DIMMs are often used in products that require higher memory capacities.

One important difference between registered DIMMs and unbuffered DIMMs is the required number of clock pins for the central processor. A registered DIMM only requires 1 clock pin for sending 1 set of clock signals, whereas the unbuffered DIMM requires 3 clock pins for sending 3 sets of clock signals. Therefore, if the central processor of the computer system is capable of only supporting registered DIMMs, such as an AMD K8 Opteron CPU, the computer system will be unable to use unbuffered DIMMs.

However, registered DIMMs are more expensive and have slower speeds; if the computer system only supports registered DIMMs and not unbuffered DIMMs, the computer system will have fewer memory options and higher costs.

Although, U.S. Pat. No. 6,711,464 discloses a technology that permits registered/buffered memory modules to be used as regular registered/buffered memory modules or as unbuffered memory modules by enabling or disabling the register or buffer of the registered/buffered memory module. But a computer system with this technology still requires more expensive registered memory modules to serve as unbuffered memory modules. Therefore, U.S. Pat. No. 6,711,464 does not resolve the issue of high costs.

Therefore, it is desirable to provide a computer system and method for selectively supporting at least one registered dual inline memory module or at least one unbuffered dual inline memory module to mitigate and/or obviate the aforementioned problems.

### SUMMARY OF THE INVENTION

A main objective of the present invention is to provide a computer system and method for selectively supporting at least one registered dual inline memory module or at least one unbuffered dual inline memory module, which increases convenience and memory selection options.

In order to achieve the above-mentioned objective, the present invention provides a computer system for selectively supporting at least one registered dual inline memory module or at least one unbuffered dual inline memory module. The computer system comprises a printed circuit board (PCB), at least one registered/unbuffered dual memory module socket, a processor, at least three sets of signal wires and a BIOS.

The at least one registered/unbuffered dual memory module socket is disposed on the printed circuit board, wherein each registered/unbuffered dual mode memory module socket is configured for selectively accepting a registered memory module or an unbuffered memory module; the processor is disposed on the printed circuit board and is configured for sending three sets of clock signals to each registered/unbuffered dual mode memory module socket, wherein one set of clock signals is provided for the registered memory module and the unbuffered memory module to share, and the other sets of clock signals are provided for the unbuffered memory module; at least three sets of signal wires are disposed on the printed circuit board and are configured for sending three sets of clock signals from the processor to the registered/unbuffered dual mode memory module socket; and basic input/output system (BIOS) is disposed on the printed circuit board, the BIOS capable of detecting a memory type of a memory module inserted in each of the at least one registered/unbuffered dual mode memory module socket.

In an embodiment, three clock pins of the processor are connected to three corresponding pins of each registered/unbuffered dual mode dual inline memory module socket to send the three sets of clock signals from the processor to each registered/unbuffered dual mode dual inline memory module socket. A Pitch of each of the at least three sets of signal wires substantially corresponds to pitch requirements of the registered memory module and pitch requirements of the unbuffered memory module.

In one embodiment of the present invention, at least one unbuffered memory module socket is provided for accepting the registered memory module; or at least one unbuffered memory module socket is provided for accepting the unbuffered memory module.

In one embodiment of the present invention, the registered memory module is a registered DIMM, and the unbuffered memory module is an unbuffered DIMM. Furthermore, the processor is a CPU.

Furthermore, the present invention also provide a method for enabling a computer system to selectively accept at least one registered memory module or at least one unbuffered memory module, the computer system comprising a processor and a BIOS, the method comprises:

1. configuring at least one registered/unbuffered dual memory module socket, wherein each registered/unbuffered dual memory module socket is configured for selectively accepting a registered memory module or an unbuffered memory module;

2. sending at least three sets of clock signals to each registered/unbuffered dual memory module socket, wherein one set of clock signals is provided for the registered memory module and the unbuffered memory module to share, and the other sets of clock signals are provided for the unbuffered memory module; and

3. providing at least three sets of signal wires for sending the at least three sets of clock signals to such that a pitch of each of the at least three sets of signal wires substantially corresponds to pitch requirements of the registered memory module and pitch requirements of the unbuffered memory module; and

4. detecting each registered/unbuffered dual memory module socket to determine whether a registered memory module or an unbuffered memory module is inserted in the registered/unbuffered dual memory module socket.

In one embodiment of the present invention, the method of the present invention further comprises:

1. providing at least one registered memory module socket, wherein each registered memory module socket is configured for accepting a registered memory module; and

2. sending a set of clock signals to each registered memory module socket for the registered memory module.

Alternatively, in one embodiment of the present invention, the method of the present invention further comprises:

1. providing at least one unbuffered memory module socket, wherein each unbuffered memory module socket is configured for accepting an unbuffered memory module; and

2. sending a set of clock signals to each unbuffered memory module socket for the unbuffered memory module.

Other objects, advantages, and novel features of the invention will become more apparent from the following detailed description when taken in conjunction with the accompanying drawings.

### BRIEF DESCRIPTION OF THE DRAWINGS

FIG. 1 shows a computer system according to a first embodiment of the present invention.

FIG. 2 shows a computer system according to a second embodiment of the present invention.

FIG. 3 is a flowchart of the method of the first embodiment according to the present invention.

FIG. 4 is a flowchart of the method of the second embodiment according to the present invention

FIG. 5 is a flowchart of the method of a third embodiment according to the present invention.

### DETAILED DESCRIPTION OF THE PREFERRED EMBODIMENT

In the prior art, the memory types of certain computer systems are limited by the types of CPUS. Consequently, although the socket shared by registered/unbuffered memory modules with the standards set by JEDEC (Joint Electron Device Engineering Council)has three clock pins, if the central processor in the computer system only supports registered DIMMs, as with the AMD K8 Opteron CPU, then the computer system cannot support unbuffered DIMMs. However, the present invention enables the processor to support both registered DIMMs and unbuffered DIMMs.

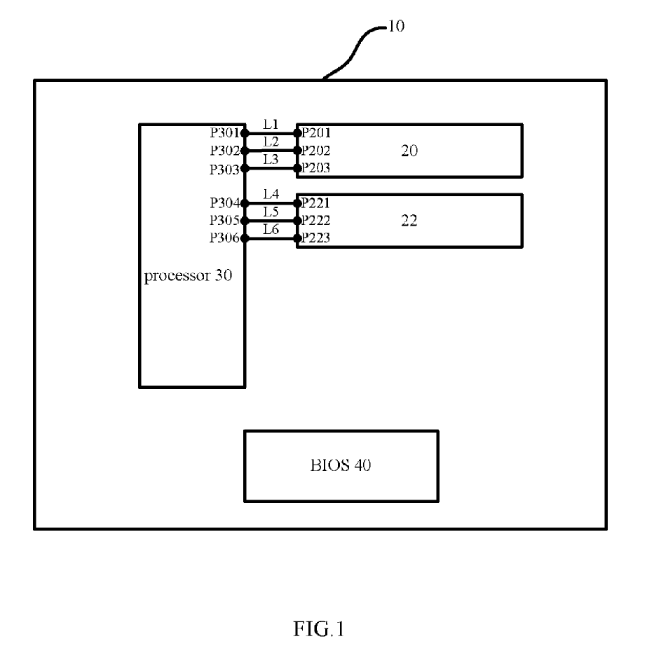

Please refer to FIG. 1. FIG. 1 shows a computer system supporting both registered memory modules and unbuffered memory modules in a first embodiment according to the present invention.

As shown in FIG. 1, the computer system of the present invention comprises a printed circuit board 10, two registered/unbuffered dual memory module sockets 20, 22, a processor 30 and a BIOS 40. The registered/unbuffered memory module sockets 20, 22, the processor 30 and the BIOS 40 are all disposed on the printed circuit board 10.

In the first embodiment, the registered/unbuffered memory module sockets 20, 22 are registered/unbuffered DIMM sockets, which can be selectively used for accepting a registered DIMM (not shown) or an unbuffered DIMM (not shown). The processor 30 is a CPU, and the printed circuit board 10 is a motherboard.

As shown in FIG. 1, the registered/unbuffered memory module socket 20 has 3 clock pins P201, P202 and P203; the registered/unbuffered memory module socket 22 has 3 clock pins P221, P222 and P223; and the processor 30 has 6 clock pins P301, P302, P303, P304, P305 and P306 individually corresponding to the 6 clock pins P201, P202, P203 and P221, P222, P223 of registered/unbuffered memory module sockets 20, 22.

The 6 clock pins P301, P302, P303, P304, P305 and P306 of the processor 30 can be electrically connected to the 6 clock pins P201, P202, P203 and P221, P222, P223 of registered/unbuffered memory module sockets 20, 22 via signal wires L1, L2, L3, L4, L5 and L6, and respectively send three sets of clock signals to the registered/unbuffered memory module sockets 20, 22. One set of clock signals (for example, the clock signal sent by the signal wires L1 or L4) is provided to the registered memory module and the unbuffered memory module to share, and the other two sets of clock signals (for example, the clock signal sent by the signal wires L2, L3 or L5, L6) are provided to the unbuffered memory module.

Registered memory modules have looser pitch requirements on each pitch of the signal wires, while unbuffered memory modules have more strict pitch requirements on each pitch of the signal wires (i.e., allowing for smaller pitch errors). Therefore, in one embodiment of the invention, the signal wires L1, L2, L3, L4, L5 and L6 are configured for respectively matching the pitch requirements of each pitch of the signal wires of the registered memory module and the unbuffered memory module.

When the registered/unbuffered memory module socket 20 or 22 accepts a registered memory module, a set of clock signals is provided to the registered memory module; and when the registered/unbuffered memory module socket 20 or 22 accepts an unbuffered memory module, three sets of clock signals are provided to the unbuffered memory module. Because the registered memory module only requires one set of clock signals and the unbuffered memory module requires three sets of clock signals, the configuration of the invention as shown in FIG. 1 is capable of supporting both the registered memory module and the unbuffered memory module.

As shown in FIG. 1, the BIOS 40 is also disposed on the printed circuit board 10 and electrically connected to the registered/unbuffered dual memory module sockets 20 and 22, as well as to the processor 30. When the registered/unbuffered dual memory module socket 20 or 22 has a registered memory module or an unbuffered memory module in it, the BIOS 40 is capable of identifying whether the module is a registered memory module or an unbuffered memory module, and then the computer system adjust settings to support a registered memory module or an unbuffered memory module as required. The BIOS 40 is used to identify the type of memory and finding the corresponding memory time parameters, but this is a well known technology, and therefore requires no further description.

Although in the embodiment shown in FIG. 1 there are only two registered/unbuffered dual memory module sockets 20 and 22, the present invention is not be limited to this number, and as long as the processor 30 can support the required clock signals, the present invention can support more registered/unbuffered dual memory module sockets. Alternatively, the present invention may also have a registered memory module socket for only registered memory modules and/or an unbuffered memory module socket for only unbuffered memory modules.

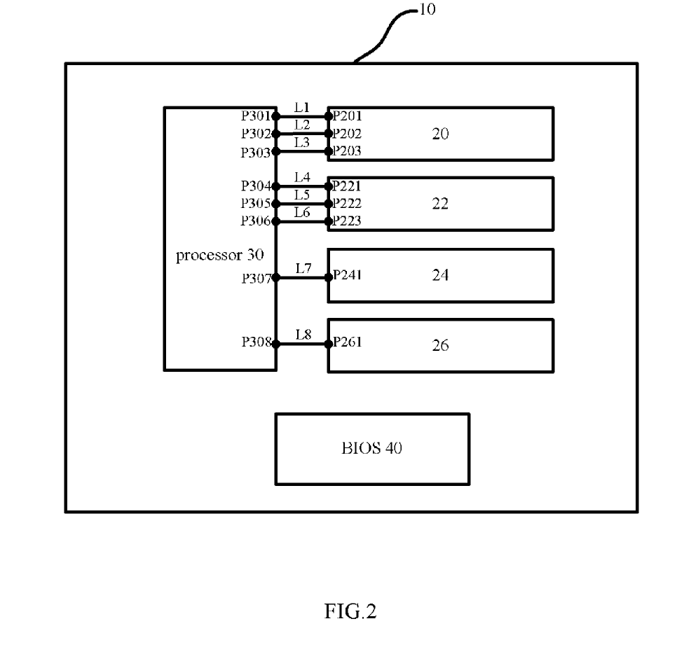

For example, as shown in FIG. 2, in a second embodiment, the processor 30 is an AMD K8 Opteron CPU and has 8 clock pins P301, P302, P303, P304, P305, P306, P307 and P308, which are indicated as (U24, U25), (AA23, Y23), (AD20, AD21), (J23, H23), (T23, R23), (L25, L24), (AE20, AE21) and (G21, G20), and which are used for sending 8 sets of clock signals. The present invention can therefore have two registered/unbuffered dual memory module sockets 20 and 22 that are connected to 6 clock pins, and two registered memory module sockets 24 and 26 for only registered memory modules that are connected to the remaining 2 clock pins P307 and P308 via the signal wires L7 and L8 with their clock pins P241 and P242; a set of clock signals can thus be sent to each registered memory module socket 24 and 26. The computer system of the present invention can thus selectively support two unbuffered memory modules, or two unbuffered memory modules and two registered memory modules, or four registered memory modules.

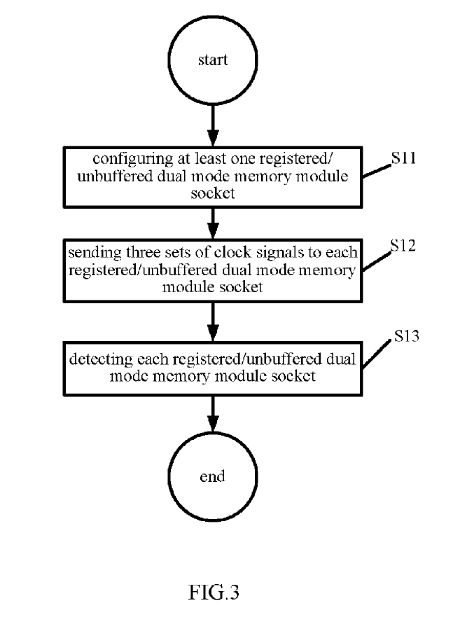

The present invention provides a method for enabling a computer system to selectively accept at least one registered memory module or at least one unbuffered memory module. Please refer to FIG. 3. FIG. 3 is a flowchart of the method in the first embodiment according to the present invention.

As shown in FIG. 3, in step S11, at least one registered/unbuffered dual memory module socket is configured. Each registered/unbuffered dual memory module socket is configured for selectively accepting a registered memory module or an unbuffered memory module. For example, as shown in FIG. 1, there are two registered/unbuffered dual memory module sockets 20 and 22.

In step S12, three sets of clock signals are respectively sent to each registered/unbuffered dual memory module socket. One set of clock signals are provided for the registered memory module and the unbuffered memory module to share, and the other sets of clock signals are provided to the unbuffered memory module. For example, as shown in FIG. 1, the processor 30 respectively sends three sets of clock signals to the registered/unbuffered dual memory module sockets 20 and 22.

Moreover, in step S12, the signal wires for sending the clock signals are designed to match the pitch requirements of the registered memory module and the pitch requirements of the unbuffered memory module.

Next, in step S13, each registered/unbuffered dual memory module socket undergoes detection to identify whether a registered memory module or an unbuffered memory module is inserted into the registered/unbuffered dual memory module socket. For example, as shown in FIG. 1, the BIOS 40 detects the registered/unbuffered dual memory module sockets 20 and 22 and identifies the type of the memory inserted into the module socket 20 and 22.

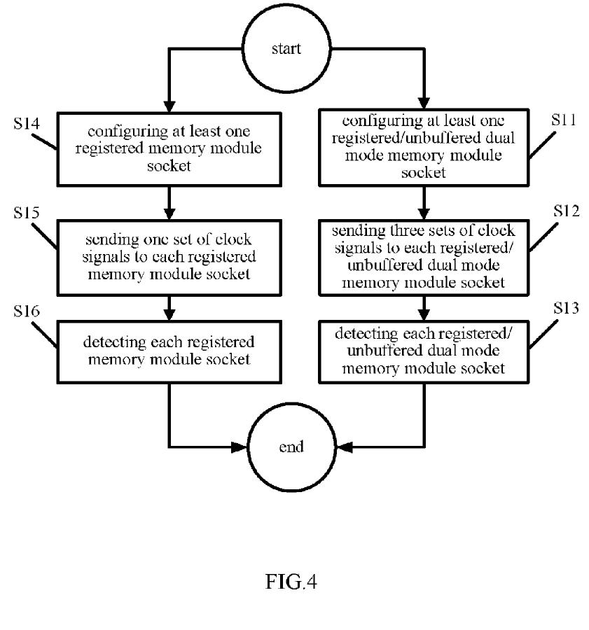

In one embodiment of the present invention, as shown in FIG. 4, in step S14, at least one unbuffered memory module socket is provided. Each unbuffered memory module socket is configured for accepting an unbuffered memory module. In step S15, a set of clock signals is sent to each registered memory module socket for the registered memory module. In step S16, the registered memory module socket undergoes detection to identify whether there is a registered memory module installed.

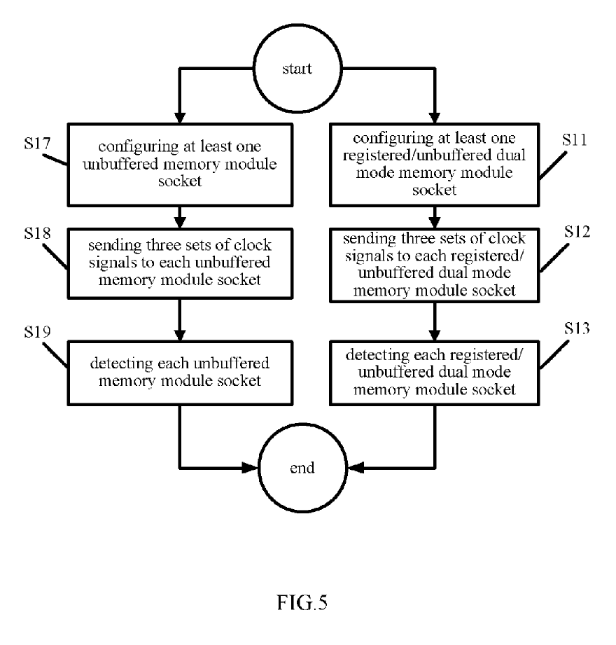

Alternatively, as shown in FIG. 5, in step S17, at least one unbuffered memory module socket is provided. Each unbuffered memory module socket is configured for accepting an unbuffered memory module. In step S18, a set of clock signals is sent to each unbuffered memory module socket for the unbuffered memory module. In step S19, the unbuffered memory module socket undergoes detection to identify whether there is an unbuffered memory module installed.

The method of the present invention enables computer systems to selectively accept at least one registered memory module and at least one unbuffered memory module.

Although the present invention has been explained in relation to its preferred embodiment, it is to be understood that many other possible modifications and variations can be made without departing from the spirit and scope of the invention as hereinafter claimed.

What is claimed is:

1. A computer system for selectively supporting at least one registered dual inline memory module or at least one unbuffered dual inline memory module, the computer system comprising:
a printed circuit board;
at least one registered/unbuffered dual mode dual inline memory module socket disposed on the printed circuit board, wherein each registered/unbuffered dual mode dual inline memory module socket is configured for selectively accepting a registered dual inline memory module or an unbuffered dual inline memory module;
a central processing unit disposed on the printed circuit board, the central processing unit capable of sending three sets of clock signals to each registered/unbuffered dual mode dual inline memory module socket, wherein one set of clock signals is provided for the registered dual inline memory module and the unbuffered dual inline memory module to share, and the other sets of clock signals are provided for the unbuffered dual inline memory module;
at least three sets of signal wires disposed on the printed circuit board, the at least three sets of signal wires used for sending the three sets of clock signals from the central processing unit to each registered/unbuffered dual mode dual inline memory module socket; and
a basic input/output system disposed on the printed circuit board, the basic input/output system capable of detecting each registered/unbuffered dual mode dual inline memory module socket to determine whether the registered dual inline memory module or the unbuffered dual inline memory module is inserted in each registered/unbuffered dual mode dual inline memory module socket.

2. The computer as claimed in claim 1, wherein a pitch of each of the at least three sets of signal wires substantially corresponds to pitch requirements of the registered dual inline memory module and pitch requirements of the unbuffered dual inline memory module.

3. The computer as claimed in claim 1 further comprising at least one registered dual inline memory module socket, wherein each registered dual inline memory module socket is capable of accepting a registered dual inline memory module.

4. The computer as claimed in claim 1 further comprising at least one unbuffered dual inline memory module socket, wherein each unbuffered dual inline memory module socket is capable of accepting an unbuffered dual inline memory module.

5. The computer as claimed in claim 1, wherein three clock pins of the central processing unit are connected to three corresponding pins of each registered/unbuffered dual mode dual inline memory module socket to send the three sets of clock signals from the central processing unit to each registered/unbuffered dual mode dual inline memory module socket.

6. A method for enabling a computer system to selectively support at least one registered memory module or at least one unbuffered memory module, the computer system comprising a processor and a basic input/output system, the method comprising:
configuring at least one registered/unbuffered dual mode memory module socket, wherein each registered/unbuffered dual mode memory module socket is configured for selectively accepting a registered memory module or an unbuffered memory module;
sending at least three sets of clock signals to each registered/unbuffered dual mode memory module socket, wherein one set of clock signals is provided for the registered memory module and the unbuffered memory module to share, and the other sets of clock signals are provided for the unbuffered memory module; and
detecting each registered/unbuffered dual mode memory module socket to determine whether the registered memory module or the unbuffered memory module is inserted in the registered/unbuffered dual mode memory module socket.

7. The method as claimed in claim 6 further comprising:
providing at least three sets of signal wires for sending the at least three sets of clock signals such that a pitch of each of the at least three sets of signal wires substantially corresponds to pitch requirements of the registered memory module and pitch requirements of the unbuffered memory module.

8. The method as claimed in claim 6 further comprising:
providing at least one registered memory module socket, wherein each registered memory module socket is configured for accepting a registered memory module; and
sending a set of clock signals to each registered memory module socket for the registered memory module.

9. The method as claimed in claim 6 further comprising:
providing at least one unbuffered memory module socket, wherein each unbuffered memory module socket is configured for accepting a unbuffered memory module; and
sending a set of clock signals to each unbuffered memory module socket for the unbuffered memory module.

10. The method as claimed in claim 6, wherein the registered memory module is a registered dual inline memory module, and the unbuffered memory module is an unbuffered dual inline memory module.

11. The method as claimed in claim 6, wherein the processor is a central processing unit.

12. A computer system for selectively supporting at least one registered memory module or at least one unbuffered memory module, the computer system comprising:
a printed circuit board;
at least one registered/unbuffered dual mode memory module socket disposed on the printed circuit board, wherein each registered/unbuffered dual mode memory module socket is configured for selectively accepting a registered memory module or an unbuffered memory module;
a processor disposed on the printed circuit board, the processor capable of sending three sets of clock signals to each registered/unbuffered dual mode memory module socket, wherein one set of clock signals is provided for the registered memory module and the unbuffered memory module to share, and the other sets of clock signals are provided for the unbuffered memory module;
at least three sets of signal wires disposed on the printed circuit board, the at least three sets of signal wires used for sending three sets of clock signals from the processor to each registered/unbuffered dual mode memory module socket; and
a basic input/output system disposed on the printed circuit board, the basic input/output system capable of detecting each registered/unbuffered dual mode memory module socket to determine whether the registered memory module or the unbuffered memory module is inserted in each registered/unbuffered dual mode memory module socket.

13. The computer as claimed in claim 12, wherein a pitch of each of the at least three sets of signal wires substantially corresponds to pitch requirements of the registered memory module and pitch requirements of the unbuffered memory module.

14. The computer as claimed in claim 12 further comprising at least one registered memory module socket, wherein each registered memory module socket is used for accepting a registered memory module.

15. The computer as claimed in claim 12 further comprising at least one unbuffered memory module socket, wherein each unbuffered memory module socket is used for accepting a unbuffered memory module.

16. The computer as claimed in claim 12, wherein three clock pins of the processor are connected to three corresponding pins of each registered/unbuffered dual mode memory module socket to send the three sets of clock signals from the processor to each registered/unbuffered dual mode memory module socket.

17. The computer as claimed in claim 12, wherein the registered memory module is a registered dual inline memory module, and the unbuffered memory module is an unbuffered dual inline memory module.

18. The computer as claimed in claim 12, wherein the processor is a central processing unit.
